(19) United States
(12) Patent Application Publication
(10) Pub. No.: US 2010/0177474 A1
(43) Pub. Date: Jul. 15, 2010

(54) Electrical Device having a Data Carrier Locking Device and Method for Unlocking a Data Carrier

(75) Inventor: Torsten Wahler, Bad Duerrheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: CONTINENTAL AUTOMOTIVE GMBH, Hannover (DE)

(21) Appl. No.: 12/601,922

(22) PCT Filed: Apr. 25, 2008
(86) PCT No.: PCT/EP2008/055095

§ 371 Date: Nov. 25, 2009

(30) Foreign Application Priority Data
May 25, 2007 (DE) 10 2007 024 729.1

(51) Int. Cl. G06F 1/16; B23P 19/00

(52) U.S. Cl. 361/679.31; 29/426.1

(57) ABSTRACT

An electrical device, particularly an installed device for a vehicle, having a housing and having a data carrier receptacle device disposed in the housing, the data carrier receptacle device having a data carrier locking device for locking a data carrier disposed in the data carrier receptacle device. In order unlock the data carrier, even in case of operational fault, the housing has a housing recess allowing access from outside the housing to the data carrier receptacle device for unlocking the data carrier locked in the data carrier receptacle device and a non-relockable housing recess closure that can be removed from the housing recess for opening the housing recess. A method for unlocking a data carrier locked in a data carrier receptacle device having a data carrier locking device in an electrical device having a housing having a housing recess and a housing recess closure.

### PRIORITY CLAIM

This is a U.S. national stage of application No. PCT/EP2008/055095, filed on Apr. 25, 2008, which claims Priority to the German, Application No.: 10 2007 024 729.1, Filed: May 25, 2007; the content of both being incorporated herein by reference.

### BACKGROUND OF THE INVENTION

1. Field of the Invention

The invention relates to an electrical device, in particular a built-in device for a vehicle, having a housing and a data medium holding apparatus arranged in the housing. The data medium holding apparatus has a data medium locking device for the purpose of locking a data medium arranged in the data medium holding apparatus. Moreover, the invention relates to a method for unlocking a data medium, locked in a data medium holding apparatus having a data medium locking device, in an electrical device having a housing having a housing recess and a housing recess closure, in particular in a device mentioned above.

2. Prior Art

A device and a method of the abovenamed type are known from an electrical device designed as a digital tachograph for a motor vehicle. In this case, driver-specific data cards are used as data medium; an exchange of driver- and/or vehicle-specific data between a data card and the device, as well as the recording of data on the data card can be performed whenever the data card of a driver of the motor vehicle is located in the data medium holding apparatus. In order to be able to detect impermissible instances of interference in the tachograph, the housing is lead-sealed and, if appropriate, provided with an opening detection device having a housing opening switch. Furthermore, the data medium holding apparatus is provided with a data medium locking device to avoid and to prevent a data card from being intentionally or unintentionally removed from the data medium holding apparatus during the operation of the tachograph and therefore to avoid and to prevent data from being damaged and/or manipulated. If there is a malfunction, for example a failure of the electrical power supply or a total failure of the device, removal of the data card from the tachograph requires the housing to be opened, as a result of which the lead seal is damaged and/or the housing opening switch is actuated to emit an error signal.

### SUMMARY OF THE INVENTION

An object of the invention is to provide a device from which a locked data medium can be removed without opening a device housing, even in a case of a malfunction. It is also an object of the invention to specify a method that enables the data medium to be unlocked without opening the housing.

The first-mentioned object is achieved in accordance with the invention in the case of a device of the type mentioned at the beginning by virtue of the fact that the housing has a housing recess, which enables access from outside the housing to the data medium holding apparatus to unlock the data medium locked in the data medium holding apparatus, and a housing recess closure that can be removed from the housing recess in a non-relockable fashion to open the housing recess.

The inventive device is preferably a built-in device in a motor vehicle for which a particularly high protection against impermissible interference in the device is required; in particular, the device is a tachograph or a toll device for a motor vehicle, a data acquisition device for a motor vehicle preferably being involved. It is a particular advantage of the invention that there is no need to open the housing to unlock the data medium. Rather such unlocking merely requires the opening of a spatially restricted housing recess punched out portion of the housing or a housing bore. In this way, there is no need to damage a lead seal of the housing nor to actuate a housing opening switch. It is important in the case of the invention that it is possible to detect an interference in the housing nevertheless without damaging the lead seal or activating the housing opening switch: this is the case because the housing recess closure can be removed only in a non-relockable fashion from the housing recess while opening the latter. Consequently, after being opened the housing recess remains open or it is reclosed in some other way, but in any case not without detectable damage to the housing recess closure; both of these, an open housing recess and a damaged housing recess closure being capable of detection by simply looking at the inventive device. The housing recess closure is provided for opening the housing recess only once. The invention can advantageously be used to remove the data medium from the device without the need to disassemble a housing part. Unlocking the data medium is preferably enabled exclusively in a deenergized state of the inventive device. In the event of a malfunction, the data medium can be unlocked and removed from the inventive device without destroying a lead seal of the housing or removing a housing component such as a base plate. This is a considerable advantage in the case of a tachograph for a motor vehicle, since the data medium used is person-specific and must be used by a driver of the motor vehicle when carrying out his activity, in another motor vehicle. On the other hand, sanctions can be threatened depending on the country in which the driver operates, and/or on the class of the motor vehicle and this can also be the case when a lead seal of the housing is destroyed. The invention therefore gives the driver the option of continuing to conduct his business even when the tachograph is being repaired by the manufacturer or in a certified workshop. Without the invention, either the data medium would remain in the device, or the device would have to be opened, possibly under considerable risk of punishment. The inventive housing recess with the housing recess closure is preferably arranged in a housing wall, in particular in a housing bottom or a housing lid or a housing rear wall of the inventive electrical device.

The data medium can be of any desired design and, for example, be a magnetic tape or a compact disk. However, it is particularly advantageous with particular regard to ease of manipulation of the data medium and a high degree of data security when, the data medium is a data card, preferably a chip card or smart card.

In accordance with another embodiment of the invention, the data medium holding apparatus is a read and/or write apparatus for the data medium, as a result of which the design of the inventive device is simplified and a reliable data exchange between data medium and device is enabled when reading and/or writing the data owing to the locking of the data medium.

The production of the device can advantageously be simplified when, in accordance with another development of the invention, the housing recess closure has a housing component of a housing wall of the housing. The housing recess closure is preferably itself the housing component.

In accordance with another advantageous development of the invention, at least one housing wall opening is arranged between the housing recess closure and a wall region of the housing wall bordering the housing recess closure. A plurality of such housing wall openings are preferably provided in a fashion forming a perforation of the housing wall. Along such a perforation, which forms a tear line, it is possible to separate the housing recess closure easily from the bordering wall region of the housing wall in a fashion opening the housing recess. It is particularly advantageous that in the case of the inventive device the housing wall opening can be kept very small such that, for example, it is possible to achieve an IP40 protection rating for the housing with the aid of the invention. Moreover, the housing wall opening can also be produced easily and cost effectively when producing the housing wall.

In accordance with another advantageous development of the invention, the housing recess closure is connected by at least one web to the wall region of the housing wall bordering the housing recess closure. For example, the web can be used to continue to hold the opened housing recess closure on the housing, so as to prevent the housing recess closure from inadvertently falling into the interior of the housing, something which could possibly lead to damage to the device, for example by formation of an electrical short circuit.

A particularly good protection of the interior of the device against environmental influences such as dust and moisture can be attained in an advantageous way when between the housing recess closure and the wall region of the housing wall bordering the housing recess closure, the housing wall has a wall thickness reduced by comparison with a wall thickness of the housing recess closure and a wall thickness of the bordering wall region. In this way, a housing wall can be present that is completely closed in the region of the housing recess closure and from which the housing recess closure can be separated as required, for example in conformity with the opening of a tin of fish. For example, even in the case of an above described perforation, an above named reduced wall thickness can be advantageous in order to be able to separate the housing recess closure easily from the bordering wall region.

In accordance with another advantageous development of the invention, the housing recess closure has a seal at least partially covering the housing recess. It is conceivable both to provide the seal as a single housing recess closure, and to combine the seal with a perforation of the housing.

A good protection of the seal against inadvertent mechanical damage can be achieved by virtue of the fact that, in accordance with another advantageous development of the invention, the seal is arranged on the inside of the housing facing the data medium holding apparatus.

In accordance with another advantageous development of the invention, protection of the seal against mechanical damage can be achieved or at least improved, by virtue of the fact that the seal is arranged in a housing depression. Such an arrangement is of particular advantage whenever the seal is located on the outside of the housing averted from the data medium holding apparatus, since in this case there is an increased risk of damage to the seal, for example when building the inventive device into a motor vehicle.

An advantageously easy unlocking of the data medium can be achieved in accordance with another development of the invention by virtue of the fact that a drive element, which can be one of various gear wheels in a gear train, of a drive for driving the data medium locking device can be accessed through the housing recess, preferably directly, such that the data medium can be unlocked by appropriate movement of the drive element, preferably by a suitable tool.

A very easy unlocking of the data carrier and a possibility reliably of restricting the use of the opened housing recess to the envisaged aim of the unlocking of the data medium is met by providing the housing recess with as small an opening surface so that the data medium holding apparatus has a driving pinion for actuating the data medium locking device, and in that it is possible to access the driving pinion directly through the housing recess. Whenever the driving pinion is arranged directly on a motor shaft of a motor driving the data medium locking device, a further advantage accrues in this case that a detent torque of the motor can be overcome with particular ease. The driving pinion is preferably a first drive element of a drive for driving the data medium locking device.

A second object is achieved by a method such that the housing recess closure is removed from the housing recess in a non-relockable fashion, that a tool is introduced into the housing through the open housing recess and is brought into engagement with the data medium holding apparatus. The tool is used to actuate the data medium locking device and to unlock the data medium in the data medium holding apparatus.

The removal of the housing recess closure from the housing recess opens the latter. In accordance with the invention, the opened housing recess with the removed housing recess closure cannot be relocked and the opening of the housing recess can be permanently detected. The tool to be used for the inventive method can advantageously be a hand tool for example a screwdriver or a stylus such as a ballpoint pen. It is advantageous when an unlocking of the data medium in accordance with the inventive method is entered into a data memory of the device and is thereby electronically documented.

It could be thought that the tool for unlocking the data medium is moved rectilinearly, by being displaced linearly in a slot-shaped housing recess, or pushed into a housing recess rectilinearly. By contrast, the force to be applied via the tool for the purpose of actuating the data medium locking device can be particularly well applied when, in accordance with an advantageous development of the invention, the tool is rotated, that is to say is moved on a circular track and/or in a fashion rotating about an axis of the tool, for the purpose of unlocking the data medium.

The unlocking of the data medium can proceed very easily and simply when, in accordance with another advantageous development of the invention the tool is brought into engagement with a driving pinion, actuating the data medium locking device, of the data medium holding apparatus, and the data medium is unlocked by rotating the tool.

It would be conceivable to take the data medium out of the housing after the unlocking with the aid of a pair of tongs or of tweezers, for example. However, a substantially simplified access to the data medium by the hand of an operator can be performed when, in accordance with another advantageous development of the invention, the data medium is guided at least partially out of the housing during or after being unlocked.

### BRIEF DESCRIPTION OF DRAWINGS

Exemplary embodiments of the invention are illustrated in the attached schematic drawing, and are described in more detail below. In the drawings:

FIG. 1 is an electrical device in a perspective view from below;

FIG. 2 is an enlarged detail from FIG. 1;

FIG. 3 is a data medium holding apparatus of the device according to FIG. 1, and a portion of a data medium in a perspective view from above;

FIG. 4 is a segment of the data medium holding apparatus according to FIG. 3 with a locked data medium, in a plan view;

FIG. 5 is the device according to FIG. 1 in a perspective sectional view from below;

FIG. 6 is an enlarged detail from FIG. 5;

FIG. 7 is a segment of the device according to FIG. 1 with an opened housing recess in sectional side view;

FIG. 8 is a housing wall of another electrical device;

FIG. 9 is a housing wall of a further electrical device in a first perspective view

FIG. 10 is the housing wall according to FIG. 9 in a second perspective view; and

FIG. 11 is a segment of a housing wall of a further electrical device in a sectional view.

### DETAILED DESCRIPTION OF THE DRAWINGS

Respectively corresponding elements are provided with the same reference numerals in all the figures.

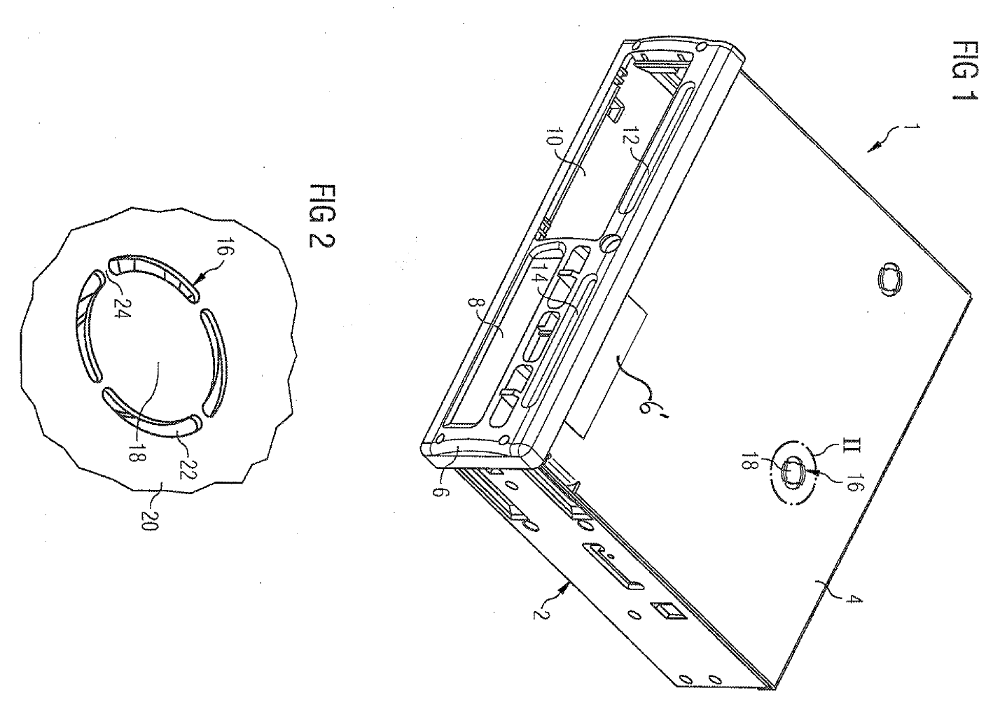

FIG. 1 shows an electrical device 1 that is designed as a built-in device, specifically as a digital tachograph, for a motor vehicle, in particular a commercial vehicle, and has a housing 2. The housing 2 has, inter alia, a first housing wall 4 in the form of a housing bottom, and a second housing wall 6 in the form of a front plate with a lead seal 6′, shown schematically, of the housing 2. The front plate is provided with an opening 8 for a display unit, and an opening 10 for a printer unit of the tachograph, the display unit and printer unit not being further illustrated here. Moreover, the front plate has two insertion slots 12, 14 for data media designed as data cards. Two data medium holding apparatuses are arranged in the housing 2 in a fashion corresponding to the insertion slots 12, 14.

Furthermore, within the housing bottom the housing 1 has a housing recess 16, assigned to a first data medium holding apparatus of the two data medium holding apparatuses, with a housing recess closure 18. A corresponding housing recess with a housing recess closure is also assigned to the second data medium holding apparatus.

The housing recess 16 assigned to the first data medium holding apparatus is illustrated for the purpose of further explanation in an enlarged fashion in FIG. 2 as the detail II from FIG. 1. It may be seen that the housing recess closure 18 in this exemplary embodiment is a housing component of a first housing wall 4, specifically the housing bottom, of the housing 1.

Four housing wall openings 22 are preferably arranged between the housing recess closure 18 and a wall region 20, bordering the housing recess closure 18, of the first housing wall 4. By way of example, the housing wall openings 22 can be stamped out from the first housing wall 4, which can be a sheet component.

The housing recess closure 18 is connected by means of webs 24 to the wall region 20, bordering the housing recess closure 18, of the first housing wall 4. The webs 24 separate the housing wall openings 22 from one another such that the housing wall openings 22 form a perforation in the first housing wall 4. The housing recess closure 18 can be broken out along the perforation from the first housing wall 4 to free the housing recess 16. It is possible through the housing recess 16 to access from the outside of the housing 2 the abovenamed assigned data medium holding apparatus, which is arranged in the housing 2.

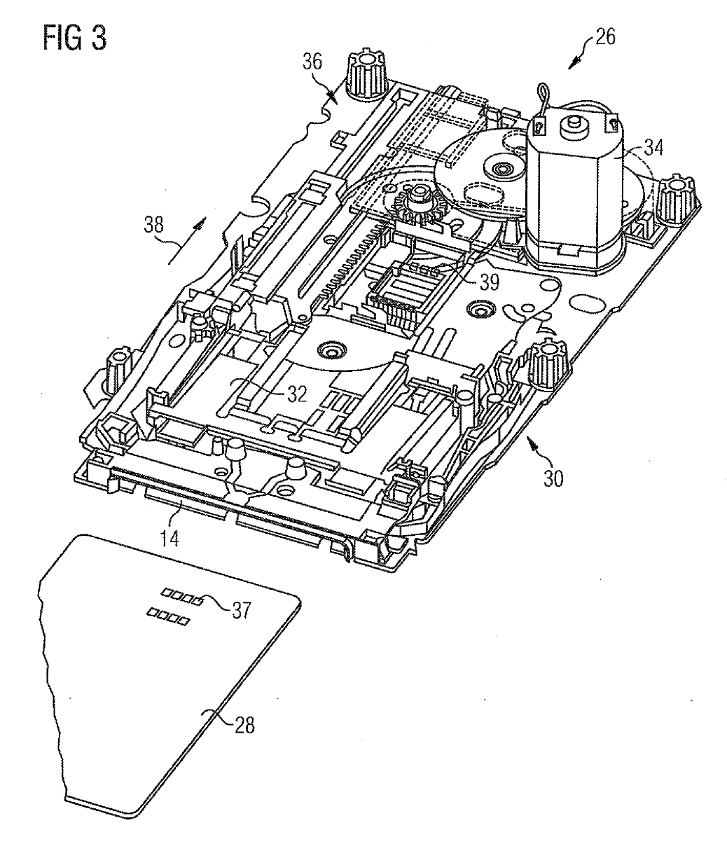

This data medium holding apparatus 26 shown in FIG. 3 in detail and together with a data medium 28 that is designed as a data card, preferably as a chip card or smart card, and is specific to the person of a driver. The data medium holding apparatus 26 has a data medium locking device 30 for locking the data medium 28 when the latter is arranged in its end position in the data medium holding apparatus 26. In the locked end position of the data medium 28 in the data medium holding apparatus 26, which is designed here as a reading and writing apparatus for the data medium 28, it is possible to exchange data between the data medium 28 and the tachograph.

To this end, the data medium 28 is pushed through the corresponding insertion slot 14 (see FIG. 1) into the housing onto a carriage 32 of the data medium holding apparatus 26. Driven via a drive 36 by an electric motor 34 designed as a geared motor in this embodiment, the carriage 32 transports the data medium 28 in the direction of a first arrow 38 completely into the housing as far as into the end position of the data medium 28, in which contact surfaces 37 of the data medium 28 make contact with contacts 39 of the data medium holding apparatus 26.

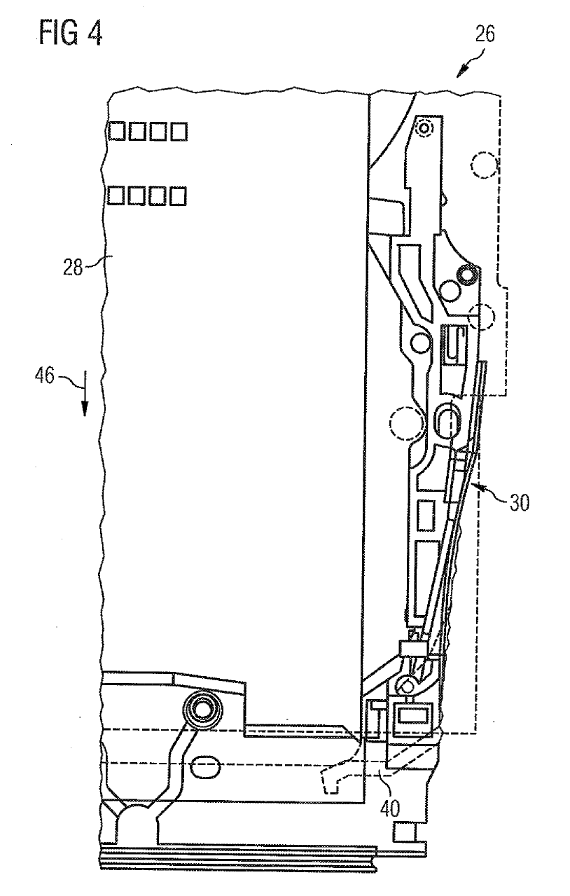

In this end position, the data medium 28 is located as illustrated in FIG. 4. It may be seen that in this position the data medium 28 is locked by the data medium locking device 30, specifically by a locking element 40 of the data medium locking device 30. The data medium locking device 30 is likewise driven by the electric motor 34 and via the drive 36.

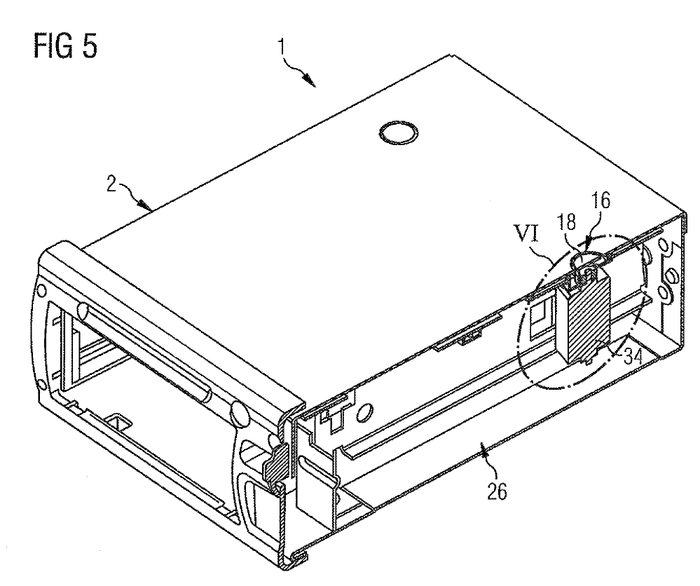

It may be gathered from FIG. 5 the a sectional view of the device 1 in a view from below, that the housing recess 16 is arranged directly below the electric motor 34, driving the data medium locking device, of the data medium holding apparatus 26, which is not completely illustrated in this view.

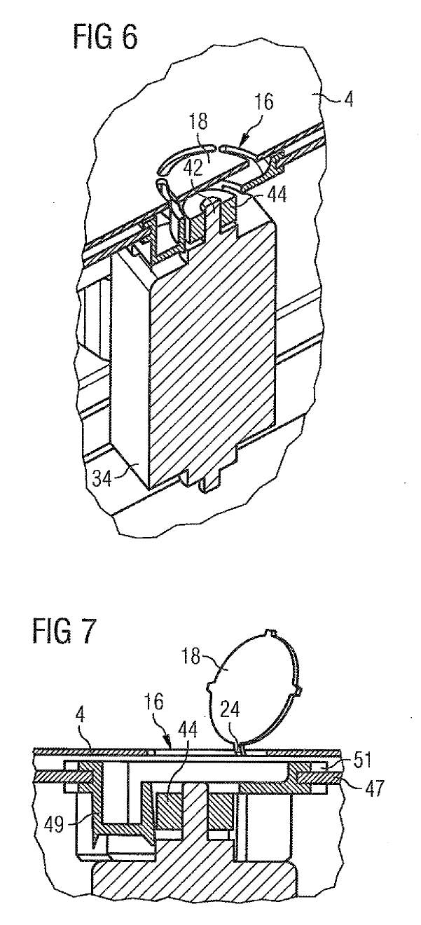

FIG. 6 illustrates an enlarged detail VI from FIG. 5, shows that a driving pinion 44 is arranged on a motor shaft 42 of the electric motor 34. The data medium locking device is driven and actuated via the driving pinion 44. The driving pinion 44 is located directly above the housing recess closure 18 of the housing recess 16.

The housing recess 16 with the housing recess closure 18 (see FIGS. 4 to 6) enables access from outside the housing 2 to the data medium holding apparatus 26 for the purpose of unlocking the data medium 28 locked in the data medium holding apparatus 26. For the purpose of access, the housing recess closure 18 can be removed from the housing recess 16, thus opening the housing recess 16 (FIG. 7). It is thereby possible to permanently detect that the housing recess 16 has been opened, since the housing recess closure 18 can be removed from the housing recess 16 exclusively in a non-relockable fashion. In this exemplary embodiment, this comes about by virtue of the fact that the housing recess closure 18 is broken out, in a fashion opening the housing recess 16, from the first housing wall 4, for example by means of a lever tool, a screwdriver, by way of example. The driving pinion 44 can be accessed directly through the opened housing recess 16.

It is advantageous when the housing recess closure 18 can be removed captively from the housing recess 16. This is achieved here by virtue of the fact that three of the four webs 24 are severed, whereas the fourth web is used to maintain a connection between the housing recess closure 18 and housing wall 4. It can also be provided that this web, which keeps the connection between the housing recess closure 18 and the housing wall 4 even after the opening of the housing recess 16, is designed to be larger, in particular wider, than the other webs that are severed.

The data medium 28 is unlocked in the following way. First the housing recess closure 18 is removed from the housing recess 16 in a non-relockable fashion. Thereafter, a tool, preferably a hand tool, is introduced into the housing 2 through the housing recess 16 and brought into engagement with the data medium holding apparatus 26, specifically directly with the driving pinion 44 of the data medium holding apparatus 26. A pin or a screwdriver, for example, can be used as tool. Subsequently, the data medium locking device 30 of the data medium holding apparatus 26 is actuated by the tool via the driving pinion 44, the result being that the data medium 28 in the data medium holding apparatus 26 is unlocked. The tool is rotated thereby driving the driving pinion 44 rotationally for the purpose of actuating the data medium locking device 30. The unlocking is performed in this exemplary embodiment by virtue of the fact that the locking element 40 pivots back and, as a result, releases the data medium for a movement in the direction of an arrow 46 pointing outward from the housing (FIG. 4). Finally, after the unlocking the data medium 28 is guided out from the housing 2 by moving the carriage 32 (FIG. 3), which is driven via the driving pinion 44 and the drive 36, said guidance being at least as far that it can be gripped by an operator and pulled out completely from the device 1.

The housing bottom is irreparably damaged when the housing recess closure 18 is removed preferably broken out from the housing recess 16. The repair that is thereby rendered necessary can be carried out in a certified workshop. However, the data medium 28 removed from the device 1 is available for further trips by the driver in the interim.

In the exemplary embodiment shown here (see FIGS. 5, 7), it is of particular advantage that a stable plate 47, for example a steel plate, is arranged in the housing 2 directly above the first housing wall 4 forming the housing bottom. It is therefore ensured in addition that when the housing recess closure 18, which already has only slight dimensions per se is removed from the housing recess 16 below the driving pinion 44 it is no longer possible to access the interior of the housing 2, in particular to access a system printed circuit board arranged there. Moreover, a motor receptacle 49 in which the driving pinion 44 is seated is provided with a shoulder 51 toward the housing bottom formed by the first housing wall 4. Owing to the shoulder 51, a lateral penetration into the device 1 through the housing recess 16 is possible only with great difficulty.

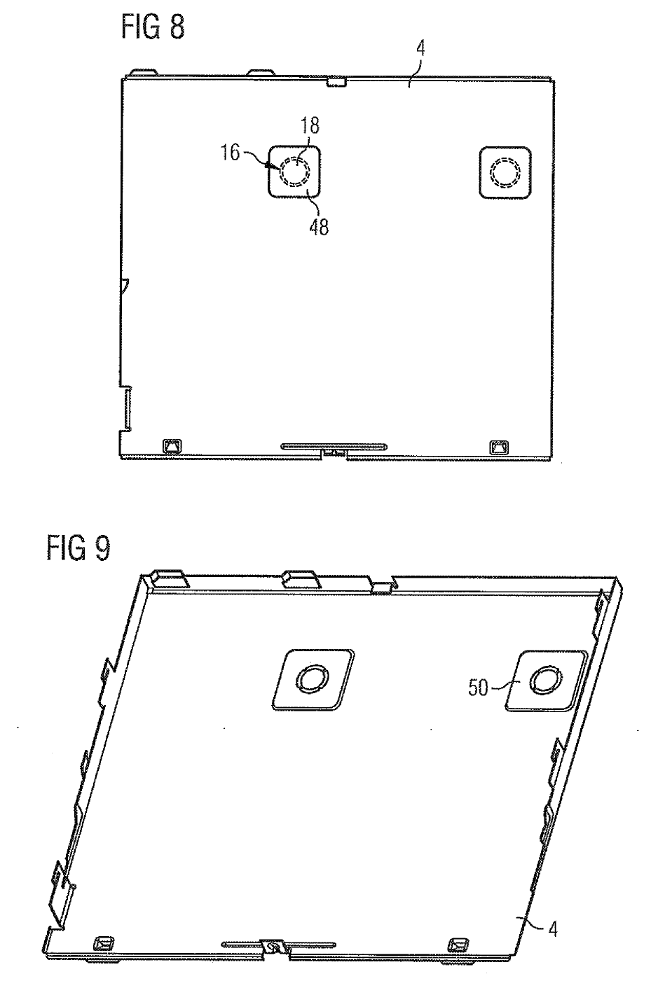

FIG. 8 shows a housing inside, facing a data medium holding apparatus, of a first housing wall 4, designed as housing bottom, of an electrical device that is not shown here in more detail and otherwise corresponds to the above described device 1 according to FIGS. 1 to 7. Housing recesses 16 are correspondingly also designed with housing recess closures 18. In addition, the housing recess closures 18 here have seals 48, in each case one of the seals 48 covering one of the housing recesses 16, and being fastened, in particular adhesively bonded, on the housing wall 4.

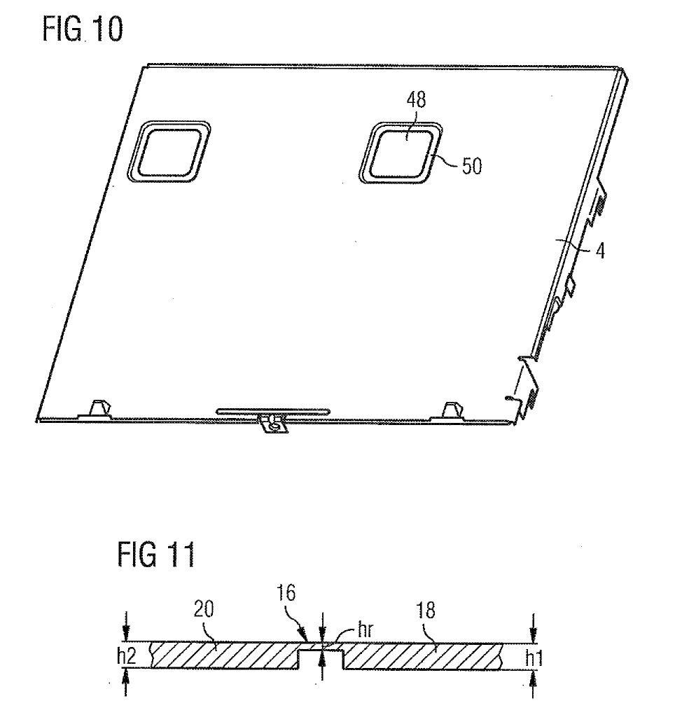

A further variant, resembling the embodiment according to FIG. 8, is shown in FIGS. 9 and 10. Here, a first housing wall 4, designed as housing bottom, of an electrical device 1 additionally has as otherwise described above according to FIGS. 1 to 7 housing depressions 50 in which housing depressions 50 a seal 48 is arranged in each case. FIG. 9 shows a having inside facing a data medium holding apparatus. FIG. 10 shows an outside, averted from the data medium holding apparatus, of the first housing wall 4. The seals 48 are fastened from outside on the first housing wall 4 and are protected by the housing depressions 50.

It is also conceivable in the case of the variants according to FIGS. 8 to 10 that the housing recess closures 18 are formed exclusively from in each case one of the seals 48.

FIG. 11 shows a segment of a first housing wall with a housing recess 16 of an electrical device otherwise designed like the device 1 described according to FIGS. 1 to 7, the housing wall having a wall thickness hr reduced by comparison with a wall thickness h1 of the housing recess closure 18, and a wall thickness h2 of the bordering wall region 20 between a housing recess closure 18 and a wall region 20, bordering the housing recess closure 18, of the housing wall. The wall thickness h1 of the housing recess closure 18, and the wall thickness h2 of the bordering wall region 20 can preferably be of the same size.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. An electrical device, comprising:
a data medium holding apparatus comprising a data medium locking device configured to lock a data medium in the data medium holding apparatus; and
a housing configured to accommodate the data medium holding apparatus therein, the housing comprising:
a housing recess configured to enable access from outside the housing to the data medium holding apparatus to unlock the data medium locked in the data medium holding apparatus; and
a housing recess closure configured to be removed from the housing recess in a non-relockable fashion to open the housing recess, wherein the data medium holding apparatus is accessible only by removing the housing recess closure in the non-relockable fashion.

18. The device as claimed in claim 17, wherein the data medium is a data card.

19. The device as claimed in claim 17, wherein the data medium holding apparatus is at least one of a read apparatus and a write apparatus for the data medium.

20. The device as claimed in claim 17, wherein the housing recess closure is a portion of a housing wall of the housing.

21. The device as claimed in claim 20, wherein at least one housing wall opening is arranged between the housing recess closure and a wall region of the housing wall bordering the housing recess closure.

22. The device as claimed in claim 21, wherein the housing recess closure is connected by at least one web to the wall region of the housing wall bordering the housing recess closure.

23. The device as claimed in claim 17, wherein the housing wall has a wall thickness between the housing recess closure and the wall region of the housing wall bordering the housing recess closure reduced by comparison with a wall thickness of the housing recess closure and a wall thickness of the bordering wall region.

24. The device as claimed in claim 17, wherein the housing recess closure has a seal at least partially covering the housing recess.

25. The device as claimed in claim 24, wherein the seal is arranged on an inside of the housing, facing the data medium holding apparatus.

26. The device as claimed in claim 24, wherein the seal is arranged in a housing depression.

27. The device as claimed in claim 17, wherein a drive element configured to drive the data medium locking device is accessible through the housing recess.

28. The device as claimed in claim 17, wherein the data medium holding apparatus further comprises a drive pinion configured to actuate the data medium locking device, and
the housing recess is configured such that the driving pinion is accessible through the recess.

29. A method for unlocking a data medium locked in a data medium holding apparatus by a data medium locking device, the data medium holding apparatus arranged in a housing of an electrical device, the housing comprising a housing recess and a housing recess closure, comprising:
removing the housing recess closure from the housing recess in a non-relockable fashion to open the housing recess
introducing a tool into the housing through the open housing recess;
engaging the tool with the data medium holding apparatus;
actuating the data medium locking device with the tool to unlock the data medium in the data medium holding apparatus.

30. The method as claimed in claim 29, further comprising rotating the tool to unlock the data medium.

31. The method as claimed in claim 30, wherein the tool is brought into engagement with a driving pinion configured to actuate the data medium locking device of the data medium holding apparatus.

32. The method as claimed in one of claims 29, wherein the data medium is guided at least partially out of the housing at least one of during or after being unlocked.

33. The device as claimed in claim 17, wherein the electrical device is a built-in device for a vehicle.
